(19) United States
(12) Patent Application Publication
(10) Pub. No.: US 2011/0113284 A1
(43) Pub. Date: May 12, 2011

(54) READ RETRY METHOD AND APPARATUSES CAPABLE OF PERFORMING THE READ RETRY METHOD

(75) Inventors: Jong Oh PARK, Seoul (KR); Seung Youl Jeong, Hwaseong-si (KR)

(73) Assignee: Samsung Electronics Co., Ltd, Suwon-si (KR)

(21) Appl. No.: 12/939,328

(22) Filed: Nov. 4, 2010

(30) Foreign Application Priority Data
Nov. 6, 2009 (KR) 2009-107197

(51) Int. Cl. G06F 11/14; G06F 11/07

(52) U.S. Cl. 714/16; 714/54; 714/E11.024; 714/E11.117

(57) ABSTRACT

A read retry method performed in a hard disk drive, the read retry method may include performing a read operation; and ignoring a read error flag generated when a read error is generated, and continuing to perform the read operation.

### CROSS-REFERENCE TO RELATED APPLICATIONS

A claim of priority under 35 U.S.C. §119 is made to Korean Patent Application No. 10-2009-0107197, filed Nov. 6, 2009, in the Korean Intellectual Property Office, the disclosure of which is incorporated herein in its entirety by reference.

### BACKGROUND

1. Field of the Invention

An embodiment of the present general inventive concept relates to a data storage device, and more particularly, to a read retry method by which a read operation can be continuously performed even when a read error is generated, and apparatuses capable of performing the read retry method.

2. Description of the Related Art

In conventional hard disk drives (HDDs), a read error is generated due to head noise, off-track write, weak write, or the like or generated when a channel parameter is not optimized. In the HDDs, when a read error is generated during a read operation, the next read operation is not performed and a read retry operation is performed. The read retry operation is repeated until a read error is not generated or the number of read retry operations performed reaches a predetermined number.

### SUMMARY

The present general inventive concept provides a read retry method by which a read operation can be continuously performed by ignoring a read error flag even when a read error is generated during the read operation, and apparatuses capable of performing the read retry method.

Additional aspects and utilities of the present general inventive concept will be set forth in part in the description which follows and, in part, will be obvious from the description, or may be learned by practice of the present general inventive concept.

According to an aspect of the present general inventive concept, there is provided a read retry method performed in a hard disk drive, the read retry method including performing a read operation; and ignoring a read error flag generated when a read error is generated, and continuing to perform the read operation.

According to an embodiment, the continuing to perform the read operation includes performing the read operation with respect to the entire track including a read error generation sector until a head reaches the read error generation sector again. According to another embodiment, the continuing to perform the read operation includes performing the read operation with respect to the read error generation sector and a plurality of sectors next to the read error generation sector. According to another embodiment, the continuing to perform the read operation includes performing the read operation on sectors after the read error generation sector.

The read retry method may further include adjusting coefficients of taps of a finite impulse response (FIR) filter formed in a read/write (R/W) channel circuit when the read error is generated. The read retry method may further include initializing a channel parameter when the read error is generated. The read retry method may further include reading data from a sector in which the read error has been generated, while changing the channel parameter, when the read error is generated.

A computer readable program to execute the read retry method is recorded in a recording medium. The recording medium may include a non-transitory recording medium.

According to another aspect of the present general inventive concept, there is provided a hard disk drive including a magnetic storage medium to store data; a spindle motor to rotate a disk; a head to read the data; a pre-amplifier to amplify an output signal of the head; and a circuit block to determine on the basis of a signal output from the pre-amplifier whether a read error has been generated, and for controlling a read error flag generated when the read error has been generated to be ignored, and to control the read operation to continue to be performed.

According to an embodiment, the circuit block controls the read error flag to be ignored and the read operation to be performed on the entire track including a read error generation sector until the head reaches the read error generation sector. According to another embodiment, the circuit block controls the read error flag to be ignored and the read operation to be performed on a read error generation sector where the read error has been generated and a predetermined number of sectors next to the read error generation sector.

The circuit block adaptively adjusts coefficients of taps of an FIR filter of an R/W channel circuit formed in the circuit block while the read operation is being continuously performed. According to another aspect of the present general inventive concept, there is provided a computer system including a hard disk drive; and a processor to control an operation of the hard disk drive.

The hard disk drive includes a magnetic storage medium to store data; a spindle motor to rotate a disk; a head to read the data; a pre-amplifier to amplify an output signal of the head; and a circuit block to determine on the basis of a signal output from the pre-amplifier whether a read error has been generated, and to control a read error flag generated when the read error has been generated to be ignored, and to control the read operation to continue to be performed.

According to yet another aspect of the present general inventive concept, there is provided a read retry method performed in a hard disk drive. The read retry method comprises performing a read operation; when a read error is generated, recognizing a read error flag; and continuing to perform the read operation. The continuing to perform the read operation may include continuing to perform the read operation without stopping.

The performing the read operation may include using a head to perform the read operation with respect to a track. The recognizing a read error flag may include using the head to reach a read error generation sector located on the track in a first instance. The continuing to perform the read operation may include using the head to perform the read operation with respect to an entirety of the track until the head reaches the read error generation sector in a second instance.

In an embodiment, the continuing to perform the read operation may include performing the read operation with respect to a read error generation sector and a predetermined number of sectors following the read error generation sector. Alternatively, the continuing to perform the read operation may include performing the read operation on at least one sector after performing the read operation on a read error generation sector.

The method may further include adjusting coefficients of taps of a finite impulse response (FIR) filter formed in a read/write (R/W) channel circuit when the read error is generated.

The method may further include initializing a channel parameter when the read error is generated.

The method may further include changing a channel parameter when the read error is generated, and reading data from a sector in which the read error has been generated in correspondence with the changed channel parameter. The channel parameter may be selected from the group consisting of an off-track bias and a magneto-resistance bias.

In yet another aspect of the present general inventive concept, there is provided a non-transitory recording medium having recorded thereon a computer readable program. The program executes: performing a read operation on a magnetic storage medium having data stored in a plurality of sectors; and when a read error is generated, continuing to perform the read operation on a predetermined number of sectors without stopping the read operation.

In still another aspect of the present general inventive concept, there is a provided a hard disk drive comprising a magnetic storage medium to store data; a head to read the data and for outputting a signal based on the read data; and a circuit block to determine on the basis of the output signal whether a read error has been generated, and to recognize a read error flag generated when the read error has been generated, and to control a read operation to continue to be performed without stopping.

The circuit block may further control the read operation to continue to be performed on an entire track, including a read error generation sector, until the head reaches the read error generation sector in a second instance.

The circuit block may further control the read operation to continue to be performed on a read error generation sector where the read error has been generated and on a predetermined number of sectors following the read error generation sector. Alternatively, the circuit block may further control the read operation to continue to be performed on at least one sector starting from the read error generation sector where the read error has been generated.

The circuit block may adaptively adjust coefficients of taps of a finite impulse response (FIR) filter of an R/W channel circuit formed in the circuit block while the read operation is continuing to be performed.

The circuit block may initiate a channel parameter when the read error is generated. The circuit block may control a read retry operation to be performed while changing a channel parameter. The channel parameter may be selected from the group consisting of an off-track bias and a magneto-resistance bias.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a schematic block diagram of a hard disk drive according to an embodiment of the present general inventive concept;

FIG. 2 is a schematic plan view of a magnetic storage medium according to an embodiment of the present general inventive concept;

FIG. 3 is a flowchart of a read retry operation according to an embodiment of the present general inventive concept; and

FIG. 4 is a schematic block diagram of a computer system including the hard disk drive illustrated in FIG. 1.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

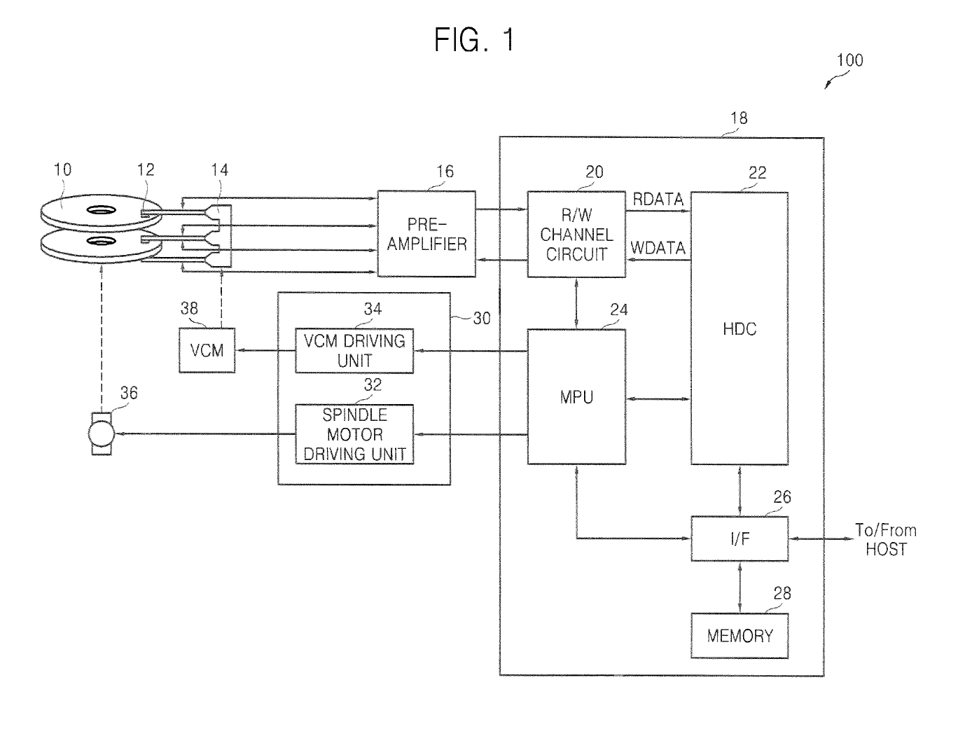

FIG. 1 is a schematic block diagram of a hard disk drive (HDD) 100 according to an embodiment of the present general inventive concept. Referring to FIG. 1, the HDD 100 includes a plurality of magnetic storage media 10, a plurality of heads 12, a head assembly 14, a pre-amplifier 16, a circuit block 18, a motor control block (or a servo control block) 30, a spindle motor 36, and a voice coil motor (VCM) 38.

Each of the magnetic storage media 10 may store data and may be rotated by the spindle motor 36. Each of the heads 12 is located over a corresponding magnetic storage medium (for example, a disk) from among the magnetic storage media 10 to perform a read operation or a write operation. Each of the heads 12 may be installed on each of a plurality of support arms extending from the head assembly 14 coupled with the VCM 38 toward the plurality of disks 10.

When data is read from a magnetic storage medium 10, the pre-amplifier 16 amplifies a read signal output from a corresponding head from among the heads 12 and outputs an amplified read signal to a read/write (R/W) channel circuit 20. When data is written to a magnetic storage medium 10, the pre-amplifier 16 transmits a write signal, for example, a write current, output from the R/W channel circuit 20 to a corresponding head from among the heads 12. Thus, the corresponding head may write the write signal to a corresponding magnetic storage medium from among the magnetic storage media 10.

The R/W channel circuit 20 converts the amplified read signal obtained by the pre-amplifier 16 into read data RDATA and outputs the read data RDATA to a hard disk controller (HDC) 22. The R/W channel circuit 20 converts write data WDATA output from the HDC 22 into a write signal and outputs the write signal to the pre-amplifier 16. In some embodiments, the R/W channel circuit 20 may transmit servo information to a micro processing unit (MPU) 24 in response to a servo gate signal output from the MPU 24.

When data is written to a magnetic storage medium, the HDC 22 outputs write data output from a host to the R/W channel circuit 20 under the control of the MPU 24. Accordingly, the write data output from the host may be written to one magnetic storage medium from among the magnetic storage media 10 via the R/W channel circuit 20, the pre-amplifier 16, and a corresponding head 12. When data is read from a magnetic storage medium, the HDC 22 may receive read data RDATA decoded by the R/W channel circuit 20 and transmit the decoded read data RDATA to the host via an interface (I/F) 26, under the control of the MPU 24. In some embodiments, the I/F 26 may be installed in the HDC 22.

The MPU 24 may control the entire operation of the HDC 22. Thus, the MPU 24 may control a read operation or a write operation of the HDD 100. The MPU 24 may receive a read command or a write command output from the host via the I/F 26 and may control a VCM driving unit 34 and a spindle motor driving unit 32 to control track seek or track following according to the read command or the write command. Although the MPU 24 controls an operation of the motor control block 30 in FIG. 1, the HDC 22 may output control signals for controlling the operation of the motor control block 30 to the motor control block 30 under the control of the MPU 24.

The spindle motor driving unit 32 may control an operation of the spindle motor 36 to control rotations of the magnetic storage media 10, in response to a control signal output from the MPU 24. The VCM driving unit 34 generates a driving current to drive the VCM 38 and outputs the driving current to a voice coil of the VCM 38, in response to a control signal to control the position of each of the heads 12, the control signal being output from the MPU 24. Accordingly, the VCM 38 may move the heads 12 to a position over a track formed in a magnetic storage medium that stores data to be read from among the magnetic storage media 10 on the basis of a direction and level of the driving current received from the VCM driving unit 34.

The heads 12 moved by the VCM 38 output position information recorded on the disks 10 to the pre-amplifier 16, on the basis of a control signal output from the R/W channel circuit 20.

When a head 12 moves to a target track of the magnetic storage media 10 from which data is to be read, the MPU 24 output a servo gate signal to the R/W channel circuit 20. The R/W channel circuit 20 reads a servo pattern from the magnetic storage media 10 in response to the servo gate signal. A memory 28, which may be implemented into a buffer memory, may store read data or write data output from the I/F 26.

According to an embodiment, the circuit block 18, including the R/W channel circuit 20, the HDC 22, the MPU 24, the I/F 26, and the memory 28 may be formed into a single chip, for example, a system on chip (SoC). According to another embodiment, the memory 28 may be formed into a special chip. The MPU 24 or the HDC 2 generates a read error flag when a read error is generated during a read operation. The read error flag is a signal that indicates generation of the read error.

When the read error is generated, the MPU 24 or the HDC 22 may control the HDD 100 to ignore the read error flag and to continue to perform the read operation.

When the read error is generated, the R/W channel circuit 20 may ignore the read error flag and receive a read signal from the magnetic storage media 10, thereby controlling the values of taps of an FIR filter. The motor control block 30, including the spindle motor driving unit 32 and the VCM driving unit 34, may be formed into a single chip.

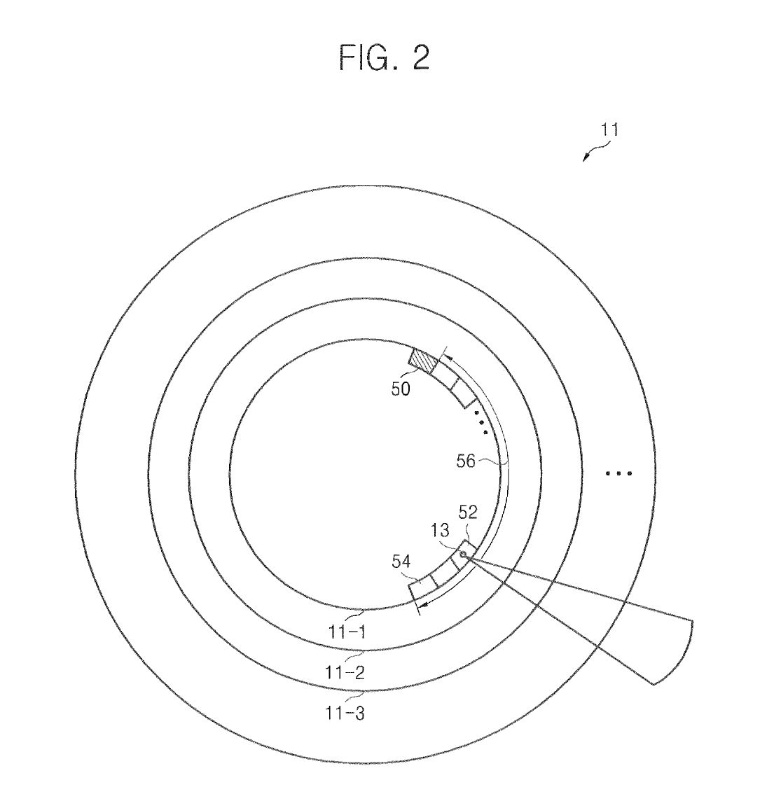

FIG. 2 is a schematic plan view of a magnetic storage medium 11 from among the magnetic storage media 10, according to an embodiment of the present general inventive concept. The magnetic storage medium 11 includes a plurality of tracks 11-1, 11-2, and 11-3. Each of the tracks 11-1, 11-2, and 11-3 includes a plurality of sectors. Each of the sectors may store data in amounts of bytes corresponding to an integral multiple of 512 bytes, such as, for example, 1024 bytes, 2048 bytes, or 512 bytes.

The track 11-1 from among the tracks 11-1, 11-2, and 11-3 includes a read error generation sector 50 and an N-th sector 54 existing at an N-th position from the read error generation sector 50. Here, N denotes a natural number, for example, 100. One head 13 from among the heads 12 reads data stored in the plurality of sectors included in the track 11-1 from among the tracks 11-1, 11-2, and 11-3.

Referring to FIGS. 1 and 2, the MPU 24 or the HDC 22 determines whether a read error is generated in one of the sectors of the track 11-1 during a read operation, and generates a read error flag if the read error is generated. For example, detection of the read error generation sector 50 may be performed when the head 13 is located on a sector 52 after the head 13 reads data from the read error generation sector 50.

When the read error generation sector 50 is detected in the sector 52 where the head 13 is located, the MPU 24 or the HDC 22 controls an operation of the circuit block 18 so that the circuit block 18 ignores a read error flag and continues the read operation. Thus, under the control of the MPU 24 or the HDC 22, the head 13 may read data from sectors from the read error generation sector 50 to the N-th sector 54, namely, from the read error generation sector 50 to a plurality of sectors 56, or perform a read operation until the head 13 starts from the read error generation sector 50 and reaches the read error generation sector 50 again, namely, perform a read operation with respect to the entire track 11-1. This is referred to as a non-stop mode.

In other words, since a conventional HDD stops a read operation when a read error is generated or when a read error flag is generated, the conventional HDD could not adaptively control the values of the taps of the FIR filter. However, since the HDD 100, according to the present embodiment, may continuously perform a read operation in correspondence with a predetermined number of sectors or a predetermined length without stopping the read operation, the HDD 100 according to the present embodiment may adaptively control the values of the taps of the FIR filter. Thus, the HDD 100 according to the present embodiment may increase the probability of a read success during a read operation.

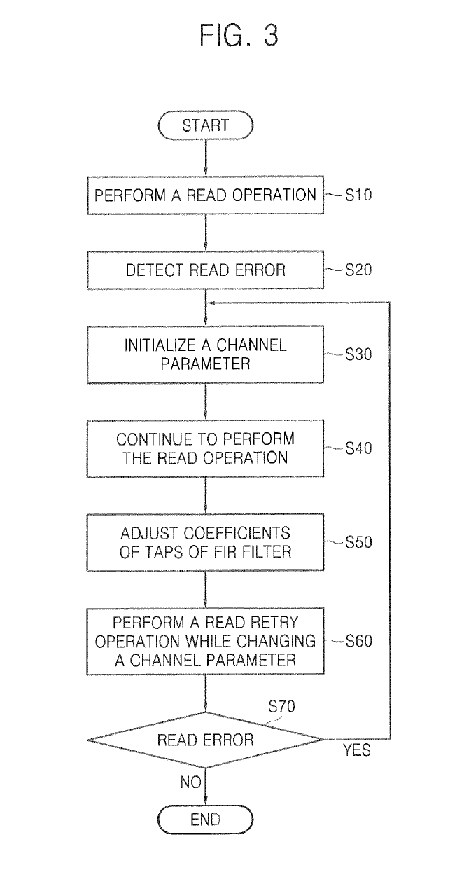

FIG. 3 is a flowchart of a read retry operation according to an embodiment of the present general inventive concept. The read retry operation will now be described with reference to FIGS. 1 through 3. In operation S10, the head 13 performs a read operation of reading data from a track formed in the magnetic storage medium 11 under the control of the circuit block 18 and the motor control block 30.

The MPU 24 or the HDC 22 detects a read error from a signal read from each of the plurality of sectors by the head 13. If the MPU 24 or the HDC 22 has detected the read error generation sector 50, the MPU 24 or the HDC 22 generates a read error flag, in operation S20. If the MPU 24 or the HDC 22 has detected the read error generation sector 50, a channel parameter, such as, for example, off-track bias or magneto-resistance (MR) bias, is initialized, in operation S30.

In operation S40, if the MPU 24 or the HDC 22 has detected the read error generation sector 50, the MPU 24 or the HDC 22 controls the HDD 100 to ignore the read error flag and to continue to perform the read operation. Even when the read error flag is generated, the read operation is not stopped but continues between the read error generation sector 50 and the N-th sector 54. According to another embodiment, even when the read error flag is generated, the read operation may be performed with respect to the entire track 11-1, including the read error generation sector 50. The signal read by the head 13 is amplified by the pre-amplifier 16, and then the amplified signal is transmitted to the R/W channel circuit 20.

Each of the values of the taps of the FIR filter may be controlled by the R/W channel circuit 20. For example, the values, for example, the coefficients, of the taps of the FIR filter are controlled on the basis of the amplified signal output from the pre-amplifier 16, in operation S50. Under the control of the MPU 24 or independently, the R/W channel circuit 20 may change the channel parameter, such as, for example, off-track or MR bias. Accordingly, the head 13 may perform a read retry operation of reading data from the read error generation sector 50 according to the changed channel parameter, in operation S60.

In operation S70, the MPU 24 or the HDC 22 determines whether a read error has been generated in the read error generation sector 50 on which the read retry operation has been performed. If the read error has been generated, the R/W channel circuit 20 initializes the channel parameter under the control of the MPU 24 or independently, in operation S30. If no read errors have been generated, the read retry operation is concluded. In some embodiments, the read error may be detected by the R/W channel circuit 20, the HDC 22, or the MPU 24, and thus a read error flag may be generated by the R/W channel circuit 20, the HDC 22, or the MPU 24.

The read retry operation according to the present embodiment may be performed by firmware or a program code, and thus a non-volatile memory device capable of storing the firmware or the program code, for example, a ROM, an EEPROM, or flash memory, may be formed inside or outside the circuit block 18. Thus, the MPU 24 may perform each of the operations illustrated in FIG. 3 by executing the firmware or program code stored in the non-volatile memory device.

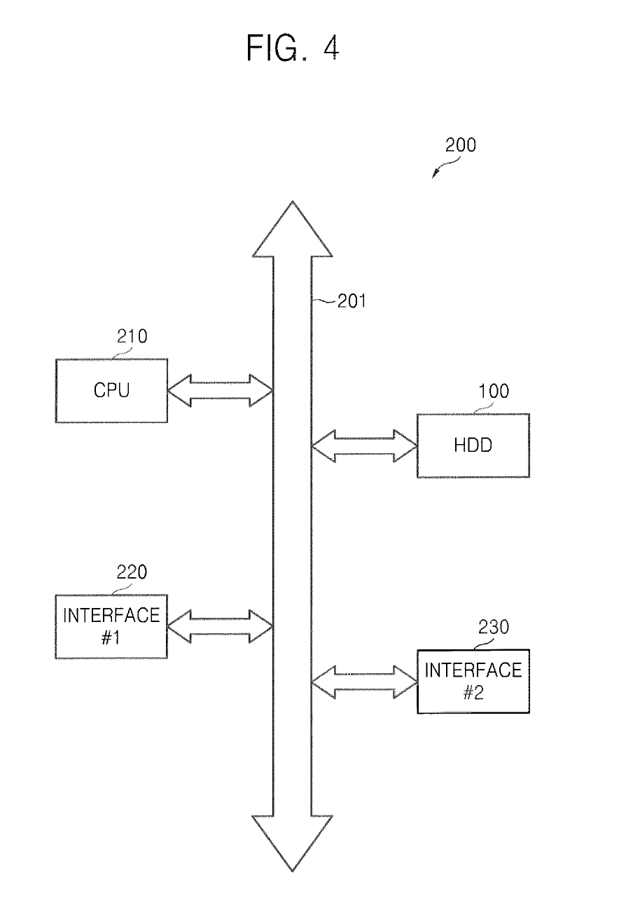

FIG. 4 is a schematic block diagram of a computer system 200 including the HDD 100 illustrated in FIG. 1. Referring to FIG. 4, the computer system 200 may be implemented into a PC, a notebook, a net-book, a portable computer, a handheld communication device, a digital TV, or a home automation device. The computer system 200 includes the HDD 100 and a central processing unit (CPU) 210 connected to each other via a system bus 201. The CPU 210 may control the entire operation of the HDD 100, for example, a read operation or a write operation.

The HDD 100 may not only perform the read retry method described above with reference to FIGS. 1 through 3, but also adaptively adjust the coefficients of the taps of the FIR filter in the non-stop mode.

The computer system 200 may further include a first interface 220. The first interface 220 may be an input/output interface. The input/output interface may be an output device, such as, for example, a monitor or a printer, or an input device, such as, for example, a mouse, a touch panel, or a keyboard. The computer system 200 may further include a second interface 230. The second interface 230 may be, for example, a wireless communication interface used to perform wireless communications with an external computer system. Accordingly, under the control of the CPU 210, the second interface 230 may transmit data stored in the HDD 100 to the external computer system by wireless or store data received from the external computer system in the HDD 100.

When the computer system 200 is implemented into a hybrid-HDD, the computer system 200 may further include a non-volatile memory device. Accordingly, the CPU 210 may store data in the HDD 100 or the non-volatile memory device according to a data storage policy.

In a read retry method and a HDD capable of performing the read retry method according to an embodiment of the present general inventive concept, the HDD may adaptively control the coefficients of taps of an FIR filter by ignoring a read error flag generated when a read error is generated, and continuing to perform a read operation. Thus, the HDD may increase the probability of a read success.

While the present general inventive concept has been particularly shown and described with reference to exemplary embodiments thereof, it will be understood that various changes in form and details may be made therein without departing from the spirit and scope of the following claims.

Although a few embodiments of the present invention have been shown and described, it would be appreciated by those skilled in the art that changes may be made in these embodiments without departing from the principles and spirit of the general inventive concept, the scope of which is defined in the claims and their equivalents.

1. A read retry method performed in a hard disk drive, the read retry method comprising:
performing a read operation; and
ignoring a read error flag generated when a read error is generated by continuing to perform the read operation.

2. The read retry method of claim 1, wherein the continuing to perform the read operation comprises using a head to perform the read operation with respect to an entire track, including a read error generation sector, until the head reaches the read error generation sector again.

3. The read retry method of claim 1, wherein the continuing to perform the read operation comprises performing the read operation with respect to a read error generation sector and a plurality of sectors following the read error generation sector.

4. The read retry method of claim 1, wherein the continuing to perform the read operation comprises performing the read operation on sectors after performing the read operation on a read error generation sector.

5. The read retry method of claim 1, further comprising adjusting coefficients of taps of a finite impulse response (FIR) filter formed in a read/write (R/W) channel circuit when the read error is generated.

6. The read retry method of claim 1, further comprising initializing a channel parameter when the read error is generated.

7. The read retry method of claim 1, further comprising:
changing a channel parameter when the read error is generated, and
reading data from a sector in which the read error has been generated in correspondence with the changed channel parameter.

8. (canceled)

9. A hard disk drive comprising:
a magnetic storage medium to store data;
a spindle motor to rotate a disk;
a head to read the data;
a pre-amplifier to amplify an output signal of the head; and
a circuit block to determine on the basis of a signal output from the pre-amplifier whether a read error has been generated, and to control a read error flag generated when the read error has been generated to be ignored and to control a read operation to continue to be performed.

10. The hard disk drive of claim 9, wherein the circuit block controls the read error flag to be ignored and the read operation to continue to be performed on an entire track, including a read error generation sector, until the head reaches the read error generation sector.

11. The hard disk drive of claim 9, wherein the circuit block controls the read error flag to be ignored and the read operation to continue to be performed on a read error generation sector where the read error has been generated and on a predetermined number of sectors following the read error generation sector.

12. The hard disk drive of claim 9, wherein the circuit block controls the read error flag to be ignored and the read operation to continue to be performed on sectors starting from the read error generation sector where the read error has been generated.

13. The hard disk drive of claim 9, wherein the circuit block adaptively adjusts coefficients of taps of a finite impulse response (FIR) filter of an R/W channel circuit formed in the circuit block while the read operation is continuing to be performed.

14. The hard disk drive of claim 9, wherein the circuit block initiates a channel parameter when the read error is generated.

15. The hard disk drive of claim 9, wherein the circuit block controls a read retry operation to be performed while changing a channel parameter.

16. A computer system comprising:
a hard disk drive: and
a processor to control an operation of the hard disk drive;
wherein the hard disk drive comprises:
a magnetic storage medium to store data;
a spindle motor to rotate a disk;
a head to read the data;
a pre-amplifier to amplify an output signal of the head; and
a circuit block to determine on the basis of a signal output from the pre-amplifier whether a read error has been generated, and to control a read error flag generated when the read error has been generated to be ignored and to control a read operation to continue to be performed.

17. The computer system of claim 16, wherein the circuit block controls the read error flag to be ignored and the read operation to continue to be performed on an entire track, including a read error generation sector, until the head reaches the read error generation sector.

18. The computer system of claim 16, wherein the circuit block controls the read error flag to be ignored and the read operation to continue to be performed on a read error generation sector where the read error has been generated and on a predetermined number of sectors following the read error generation sector.

19. The computer system of claim 16, wherein the circuit block adaptively adjusts coefficients of taps of a finite impulse response (FIR) filter of an R/W channel circuit formed in the circuit block while the read operation is continuing to be performed.

20-36. (canceled)
